(19) United States
(12) Patent Application Publication
(10) Pub. No.: US 2014/0037938 A1
(43) Pub. Date: Feb. 6, 2014

(54) Carbon Nanotube Enabled Hydrophobic-Hydrophilic Composite Interfaces and Methods of Their Formation

(71) Applicants: Chen Li, Chapin, SC (US); Xinyu Huang, Columbia, SC (US); Xianming Dai, Columbia, SC (US); Fanghao Yang, Columbia, SC (US)

(72) Inventors: Chen Li, Chapin, SC (US); Xinyu Huang, Columbia, SC (US); Xianming Dai, Columbia, SC (US); Fanghao Yang, Columbia, SC (US)

(21) Appl. No.: 13/954,214

(22) Filed: Jul. 30, 2013

Related U.S. Application Data
(60) Provisional application No. 61/741,956, filed on Jul. 30, 2012.

(51) Int. Cl. C09D 7/12

(52) U.S. Cl. CPC C09D 7/1225
USPC 428/323; 427/331; 427/535

(57) ABSTRACT

Methods are generally provided for forming a coated substrate having a plurality of carbon nanoparticles, along with the resulting coated substrates. In one embodiment, the method includes oxidizing the carbon nanoparticles to form oxygen containing end groups on the surfaces of the carbon nanoparticles; dispersing the oxidized carbon nanoparticles into a polymeric media to form an ink; and depositing the ink onto a substrate to form a coating. Generally, the coating includes the oxidized carbon nanoparticles dispersed within the polymeric material.

### PRIORITY INFORMATION

The present application claims priority to U.S. Provisional Patent Application Ser. No. 61/741,956 titled “Carbon Nanotube Enabled Hydrophobic-hydrophilic Composite Interfaces and Methods of Their Formation” of Li, et al. filed on Jul. 30, 2012, the disclosure of which is incorporated by reference herein.

### BACKGROUND

Functionalized carbon nanotubes with intriguing properties have led to striking applications in nano-composites, nano-biology, nanofluidics and catalytic chemistry. Carbon nanotubes (CNTs) with defects are generally regarded to have mechanical, electrical and thermal disadvantages. However, recent work suggests that the defected CNTs exhibit intriguing properties for many emerging applications such as nano-sensors, super conductors, catalysts, and field effect transistors. Partially hydrophobic and partially hydrophilic interfaces are attracting more attention as they exhibit many new functionalities. Nanofabrication has been used to develop hydrophobic-hydrophilic composite interfaces, which are usually costly and challenging in tuning wettability. Functionalized carbon nanotubes (FCNTs) have great potential in manipulating properties for a wide range of emerging applications such as electrical, chemical, biomedical, mechanical, thermal, and nanocomposites.

### SUMMARY

Objects and advantages of the invention will be set forth in part in the following description, or may be obvious from the description, or may be learned through practice of the invention.

Methods are generally provided for forming a coated substrate having a plurality of carbon nanoparticles, along with the resulting coated substrates. In one embodiment, the method includes oxidizing the carbon nanoparticles to form oxygen containing end groups on the surfaces of the carbon nanoparticles; dispersing the oxidized carbon nanoparticles into a polymeric media to form an ink; and depositing the ink onto a substrate to form a coating. Generally, the coating includes the oxidized carbon nanoparticles dispersed within the polymeric material.

Other features and aspects of the present invention are discussed in greater detail below.

### BRIEF DESCRIPTION OF THE DRAWINGS

A full and enabling disclosure of the present invention, including the best mode thereof to one skilled in the art, is set forth more particularly in the remainder of the specification, which includes reference to the accompanying figures, in which:

FIGS. 1A-1C shows a schematic representation of the synthesis and characterization of the hydrophobic-hydrophilic FMWCNTs from (1A) pristine MWCNTs to (1B) aqua regia oxidized MWCNTs to (1C) plasma treated FMWCNTs according to the Examples.

FIG. 1D shows a SEM image of a pristine MWCNT without defect according to the Examples.

FIG. 1E shows a SEM image of defects on slightly functionalized FMWCNT indicated by Pt ions according to the Examples.

FIG. 1F shows a SEM image of defects on deeply functionalized FMWCNT indicated by Pt ions according to the Examples.

FIG. 1G shows a SEM image of hydrophobic and hydrophilic areas on FMWCNT coated interfaces according to the Examples.

FIG. 1H shows a SEM image of interconnected cavities formed by partially hydrophobic and partially hydrophilic FMWCNTs according to the Examples.

FIG. 2A shows characterization of the wettability of hydrophobic-hydrophilic FMWCNTs interfaces on pristine CNT coated interface with tilted angle 7°.

FIG. 2B shows characterization of the wettability of hydrophobic-hydrophilic FMWCNTs interfaces on FMWCNT coated interface with tilted angle 180°.

FIG. 2C shows characterization of the wettability of hydrophobic-hydrophilic FMWCNTs interfaces on dry FMWCNT coated interface.

FIG. 2D shows characterization of the wettability of hydrophobic-hydrophilic FMWCNTs interfaces on wet FMWCNT coated interface.

FIG. 2E shows the contact angle as a function of Raman ID/IG ratio and plasma treatment time (on FMWCNT coated flat copper surface).

FIG. 3A shows cavity types and characterization of the nucleate boiling on four types of supernucleating interfaces and cavities for nucleate boiling.

FIG. 3B shows a SEM image of a two-layer copper meshes sintered on smooth copper.

FIG. 3C shows a SEM image of FMWCNTs coated mesh wires.

FIG. 3D shows pool boiling curves, where FMWCNT meshes denote “regular FMWCNT coated two-layer meshes”; Plasma-FMWCNT meshes 1—“intermediately functionalized FMWCNT coated two-layer meshes (8 min plasma treatment)”; and Plasma-FMWCNT meshes 2—“deeply functionalized FMWCNTs coated two-layer meshes (15 min plasma treatment)”.

FIGS. 4A-4D show graphs of the bubble dynamics, with FIG. 4A a comparison of the nucleation site density, FIG. 4B a Comparison of the bubble growth rate, FIG. 4C a comparison of the bubble departure frequency, and FIG. 4D a comparison of the average bubble departure size.

Repeat use of reference characters in the present specification and drawings is intended to represent the same or analogous features or elements of the present invention.

### DETAILED DESCRIPTION

The following description and other modifications and variations to the present invention may be practiced by those of ordinary skill in the art, without departing from the spirit and scope of the present invention. In addition, it should be understood that aspects of the various embodiments may be interchanged both in whole or in part. Furthermore, those of ordinary skill in the art will appreciate that the following description is by way of example only, and is not intended to limit the invention.

Chemical elements are discussed in the present disclosure using their common chemical abbreviation, such as commonly found on a periodic table of elements. For example, hydrogen is represented by its common chemical abbreviation H; helium is represented by its common chemical abbreviation He; and so forth.

As used herein, the prefix “nano” refers to the nanometer scale (e.g., from about 1 nm to about 999 nm). For example, particles having an average diameter on the nanometer scale (e.g., from about 1 nm to about 999 nm) are referred to as “nanoparticles”. Particles having an average diameter of greater than 1,000 nm (i.e., 1 μm) are generally referred to as “microparticles”, since the micrometer scale generally involves those materials having an average size of greater than 1 μm.

As used herein, the term “polymer” generally includes, but is not limited to, homopolymers; copolymers, such as, for example, block, graft, random and alternating copolymers; and terpolymers; and blends and modifications thereof. Furthermore, unless otherwise specifically limited, the term “polymer” shall include all possible geometrical configurations of the material. These configurations include, but are not limited to isotactic, syndiotactic, and random symmetries.

Generally, innovative interfaces are presently disclosed along with methods of their formation. In one embodiment, the interface is formed from functionalized multiwall carbon nanotubes (FMWCNTs) to achieve hydrophobic-hydrophilic composite wettability by introducing hydrophilic functional groups on the pristine MWCNT surfaces. The wettability can be tuned by varying the concentration and distribution of hydrophilic functional groups. Such nano-engineered interfaces can create ideal cavities to promote nucleate boiling in a controlled manner, and can also be used to transport liquid without loss, to reduce friction, and to accelerate drop movement.

According to the method of formation, carbon nanoparticles (e.g., multi-walled carbon nanotubes (MWCNTs)) are oxidized, dispersed into a polymeric media, deposited onto a substrate to form a coating, and optionally further functionalized to fine tune the hydrophilic/hydrophobic properties of the coating.

I. Oxidizing the Carbon Nanoparticles

Carbon nanoparticles are generally used as a base material of the presently disclosed coatings and methods. In one particular embodiment, the carbon nanoparticles are in the form of multi-walled carbon nanotubes (MWCNTs).

The carbon nanoparticles are first oxidized to form oxygen containing end groups on the surfaces of the carbon nanoparticles. The resulting oxidized carbon nanoparticles can include oxygen containing end groups, including but not limited to, hydroxyl groups (—OH), aldehyde groups (—CHO), carboxyl groups (—COOH), hydroperoxy groups (ROOH), or mixtures thereof. Generally speaking, many oxidation reactions will result in a combination of such groups on the nanoparticles, and may result in the formation of carboxyl groups, phenolic groups, and lactone groups, among others, on the surface of the carbon nanoparticles.

Oxidation of the carbon nanoparticles can be achieved via any suitable method. In one particular embodiment, the carbon nanoparticles are reacted with a strong acid(s) (e.g., nitric acid, hydrochloric acid, etc., or a mixture thereof). For example, an aqua regia solution can be utilized to oxidize the carbon nanoparticles.

II. Creation of a Polymeric Ink

Second, the oxidized multi-walled carbon nanotubes are dispersed into a polymeric media (e.g., containing a polymeric material, a solvent, etc.) to create an ink.

Suitable solvents can include, but are not limited to, alcohols (e.g., methanol, ethanol, propanol, etc.), water, organic solvents, and the like. Polymeric resins can include, but are not limited to, epoxy resins, theromplastic polymeric materials (e.g., polyolefins, polyesters, polyurethanes, etc.), etc. For example, the polymeric resin can include tetrafluoroethylene.

In one particular embodiment, an amphiphilic polymer can be utilized, such as a sulfonated tetrafluoroethylene based fluoropolymer-copolymer, within the polymeric resin. For instance, the sulfonated tetrafluoroethylene based fluoropolymer-copolymer available commercially under the trade name Nafion® (E. I. du Pont de Nemours and Company) is particularly suitable for use in the polymeric resin. Such a sulfonated tetrafluoroethylene based fluoropolymer-copolymer can strengthen the bonding of the coating with the substrate and introduce additional hydrophobic functional groups (—CF₂—) and hydrophilic sulfuric acid groups (—SO₃H).

III. Applying the Polymeric Ink onto a Substrate

Third, the ink is applied (e.g., coated, deposited, etc.) onto a substrate such that the oxidized carbon nanoparticles are coated onto the surface of the substrate. Application of the ink to the substrate can be performed via any known coating techniques (e.g., roll, blade, Meyer rod, air-knife coating procedures, etc.) or deposition techniques (e.g., ultrasonic spray coating, spin coating, etc.).

In one particular embodiment, an electrospray (i.e., e-spray) technique can be utilized to apply the ink to the substrate. Electrospray is an electrohydrodynamics process very similar to electrospinning; however, instead of fibers, it produces fine charged droplets. It also relies on an external electric field to break up the liquid into fine droplets and propel them towards a collector. As solvent evaporates, the droplets can disintegrate into finer droplets due to excess electrostatic repulsion from the surface charges. Compared to conventional mechanical atomizing and spraying techniques, E-spray has the following advantages: (1) it produces smaller droplets down to range of nanometers; (2) droplets has a narrower size distribution; (3) charged droplets are less likely to coagulate due to mutual repulsion; (4) motion of the charged droplets can be steered by electric field; (4) the deposition efficiency (yield) is much higher than conventional spray deposition techniques.

IV. Functionalizinq the Coating

Finally, the resulting coating can be optionally functionalized to add additional hydrophilic groups onto the oxidized carbon nanoparticles and/or polymeric material.

In one embodiment, a high energy treatment can be utilized, in the presence of oxygen. For example, the high energy treatment can be a corona or plasma treatment, such as a radio frequency (RF) plasma treatment. In one embodiment, an oxygen plasma can be used to further functionalize the coating to add more hydrophilic functional groups. The extent of functionalization can be conveniently tuned by varying the reaction time and the oxygen flow rate.

### EXAMPLES

In this study, innovative interfaces were synthesized from functionalized multiwall carbon nanotubes (FMWCNTs) to achieve hydrophobic-hydrophilic wettability. Quantitative study shows that the apparent contact angle of FMWCNT interfaces decreases from 139.8° to 13.7° with increasing plasma treatment time at a given oxygen flow rate due to the increasing concentration of the hydrophilic functional groups. The hydrophilic-hydrophobic FMWCNTs can create ideal cavities to enhance nucleate boiling in a controlled manner. It has been experimentally demonstrated that the boiling heat transfer rate and critical heat flux can be substantially enhanced by hydrophilic-hydrophobic FMWCNTs. Moreover, the bubble dynamics analysis reveals that the enhancement in heat transfer rate and critical heat flux is strongly dependent on the relative hydrophilicity, which determines local liquid distribution and evaporation heat transfer in the microlayer.

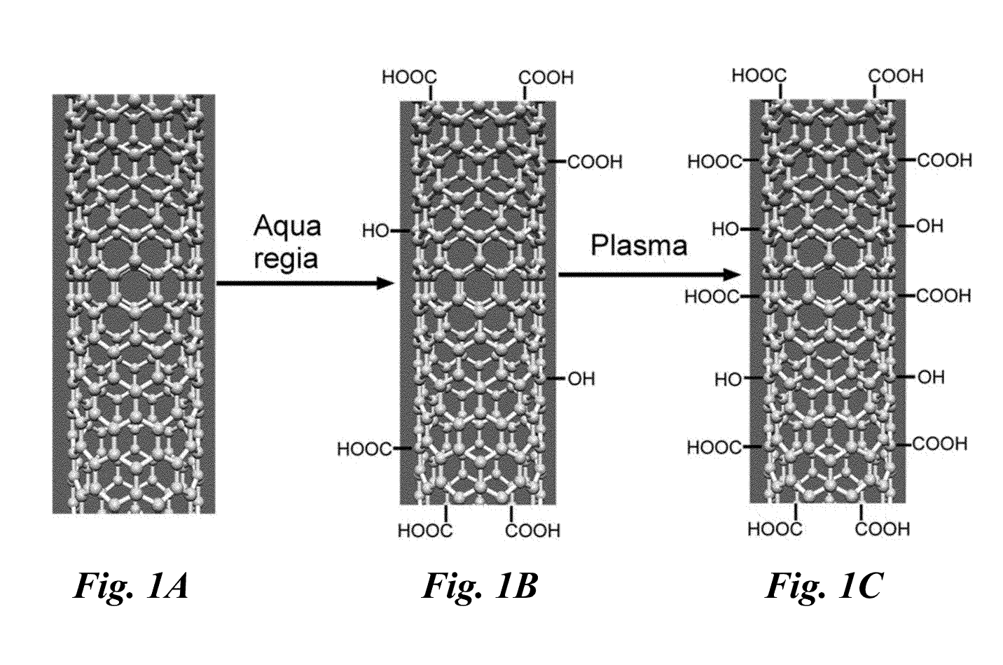

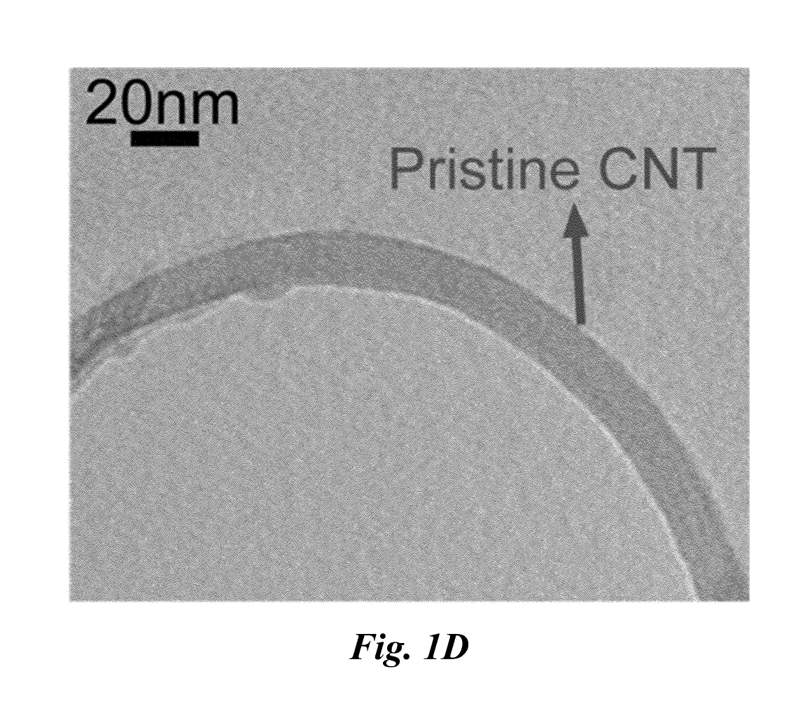

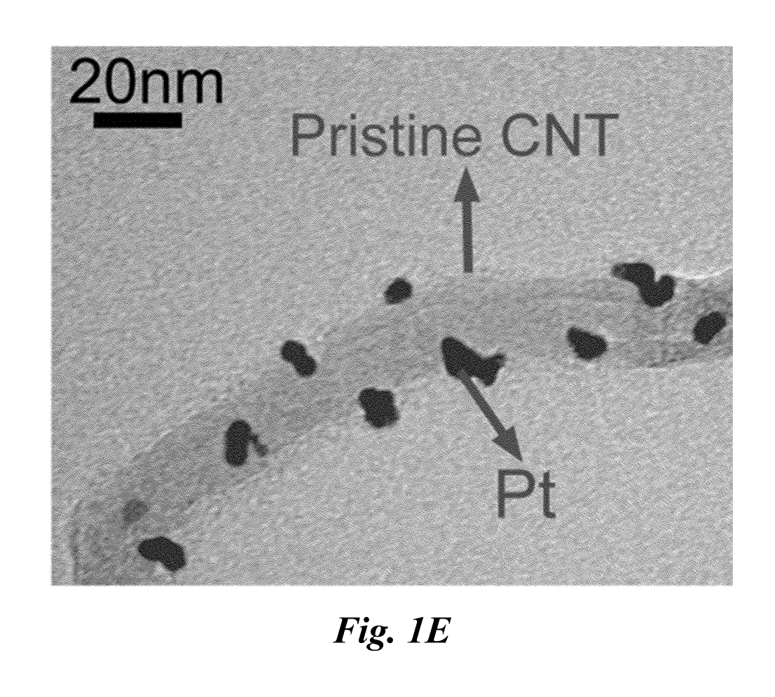

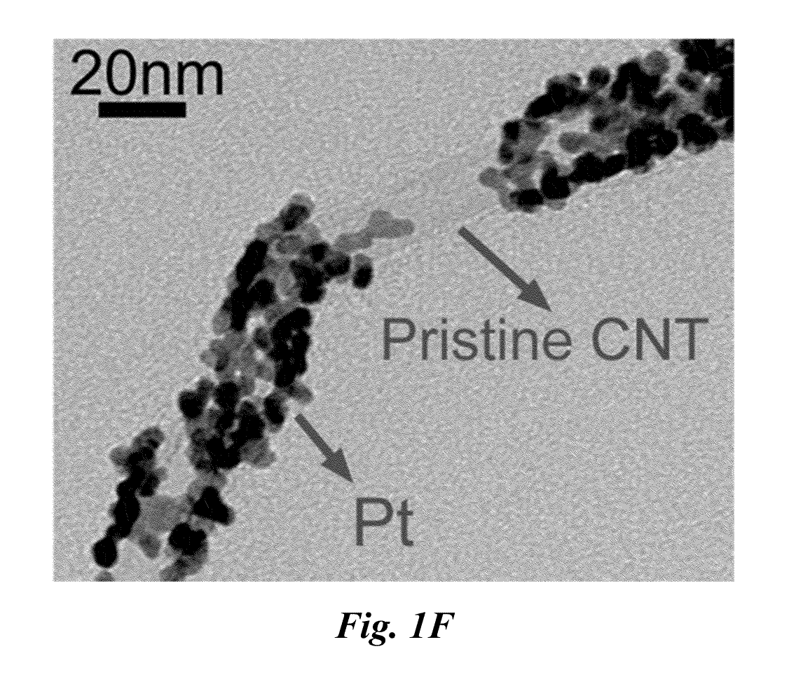

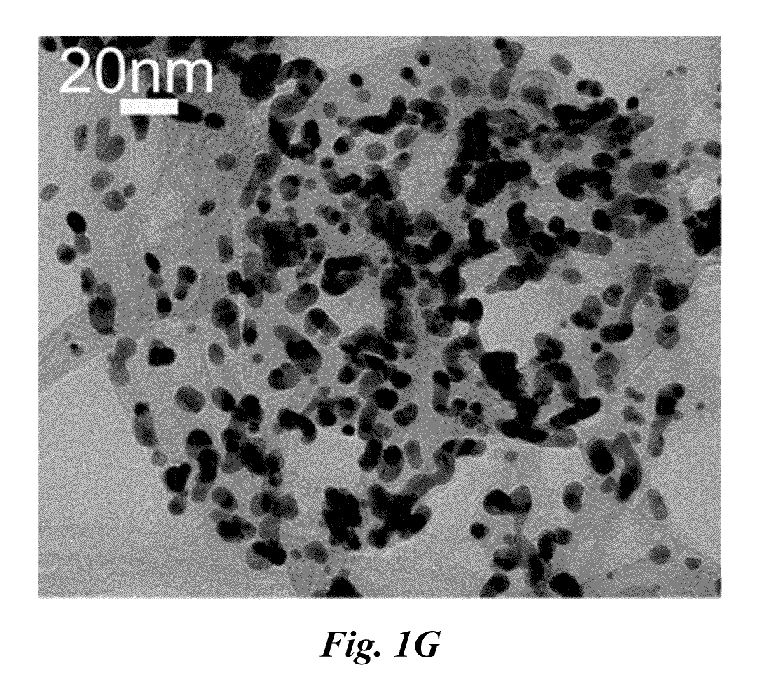

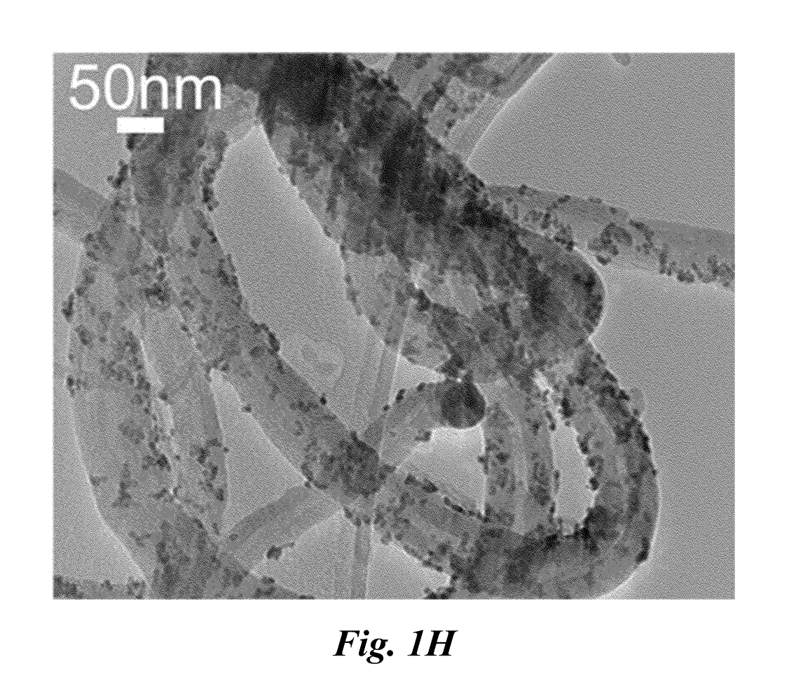

Commercially available MWCNTs were initially oxidized in the aqua regia solutions (FIG. 1b). 5 mg of synthesized FMWCNTs with 20 mg of 5% Nafion solution were then ultrasonicated and dispersed in isopropyl alcohol to form “inks”. Great dispersions of FMWCNTs were obtained after functionalizing in aqua regia solutions, ultrasonicating in isopropyl alcohol and adding amphiphilic Nafion. The well dispersed FMWCNT “inks” were deposited on the copper substrate by an ultrasonic spray coater in an electrospray technique at the flow rate of 2 mL/min. Oxygen plasma was used to further functionalize the FMWCNT coated samples, which added more hydrophilic functional groups (FIG. 1c). The extent of functionalization can be conveniently tuned by varying the reaction time and the oxygen flow rate. Here, Nafion was also used to strengthen the bonding of the FMWCNT coatings with the substrate and introduce additional hydrophobic functional groups (-CF₂-) and hydrophilic sulfuric acid groups (—SO₃H).

It is extremely challenging to directly visualize the hydrophobic-hydrophilic network on FMWCNTs. In this study, the distribution and concentration of hydrophilic groups are approximately indicated by tracer particles (FIG. 1). Positively charged platinum ions (Pt⁴⁺) from H₂PtCl₆ were used to locate the functional groups on the FMWCNT wires and bundles as the reduced platinum particles tend to nucleate on the defects of FMWCNTs. Since the functional groups grow preferentially in the defect sites, Pt loaded areas were taken favorably as functionalized regions. Regular FMWCNT wires or bundles, i.e., only treated by aqua regia, contain fewer amounts of hydrophilic functional groups (FIG. 1e) than oxygen plasma treated FMWCNTs (FIG. 1f). This observation implies the superior tunability of hydrophobic-hydrophilic composite wettability enabled by FMWCNTs. The straw-like FMWCNT coatings can randomly form a large amount of interconnected pores or cavities (FIG. 1h) with partially hydrophobic and partially hydrophilic areas (FIG. 1g).

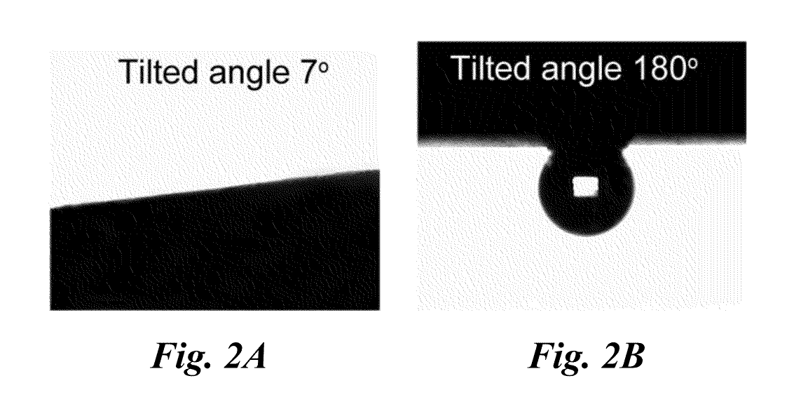

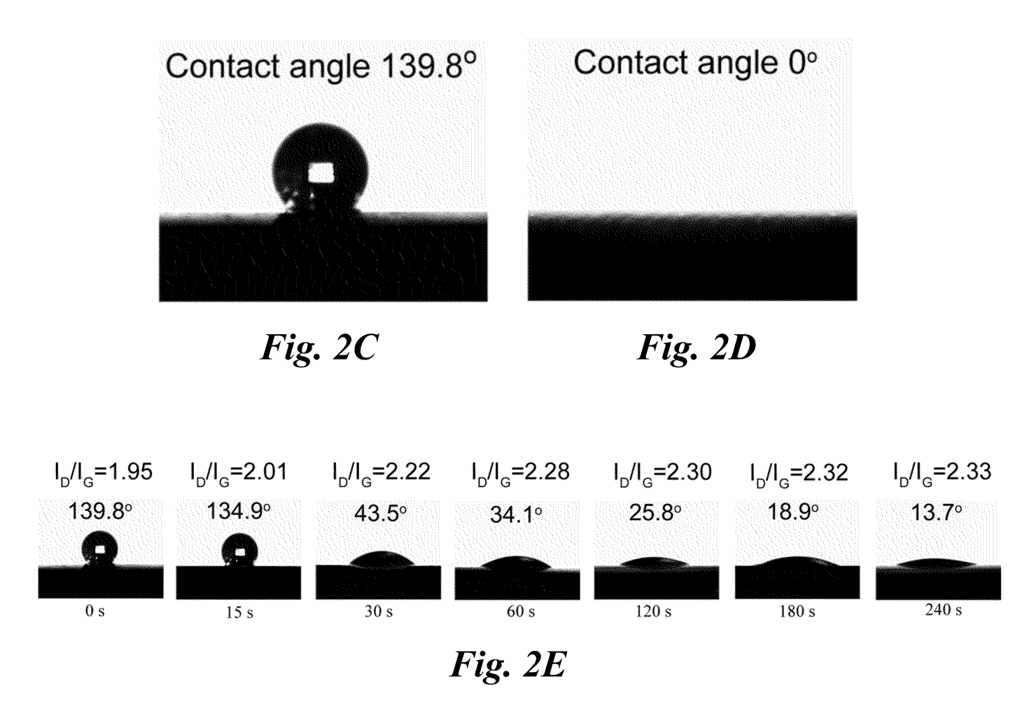

Contact angle measurement was conducted to characterize the wettability of the CNT enabled hydrophobic-hydrophilic composite interfaces. The pristine MWCNT coatings are hydrophobic and non-adhesive (FIG. 2a). The straw-like pristine MWCNT coated interface is superhydrophobic and is non-wettable even totally immersed in water. In contrast, the dry FMWCNT coatings on a flat copper substrate are apparently hydrophobic, but adhesive, which are evidenced by a water droplet adhering to the coatings with tilt angle at 180° (FIG. 2b, c). This indicates that the Van der Waals and/or the capillary force between the nanostructured interfaces and water are introduced by attaching hydrophilic functional groups. Therefore, transitions between Cassie and Wenzel states can be induced by enhancing stickiness. When the wetting behavior changes from the Cassie mode to the Wenzel mode, the liquid droplet can at least partially fill the cavities of the rough substrates with a reduced apparent contact angle. More importantly, FMWCNT interfaces are wettable (FIG. 2d). The reason is that capillary flow is induced at the solid-liquid-gas interfaces, and thus the majority of pores can be filled with water and lose its water-repellent properties as shown in FIG. 2d. These observations are consistent with the hydrophobic-hydrophilic wettability of FMWCNTs as shown in the TEM images (FIG. 1g, 1h). The relative hydrophilicity of individual FMWCNT wires and coatings can be conveniently tuned by controlling the plasma treatment time. FIG. 2e quantitatively shows that the apparent contact angle of FMWCNT interfaces decreases with increasing plasma treatment time at a given oxygen flow rate. Raman analysis shows that more defects are introduced by longer plasma treatment time, e.g. with more C═O, O—C═O and O—H groups, which are indicated by an increasing ID/IG ratio. This novel interface can be used to transport liquid without loss, to reduce friction, and to accelerate drop movement.

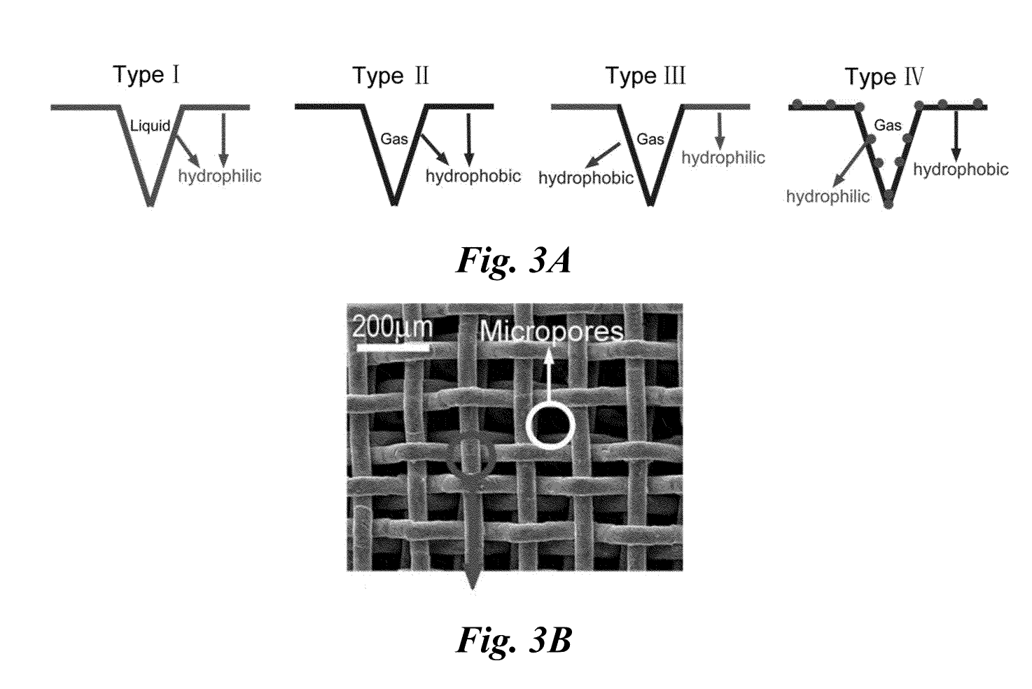

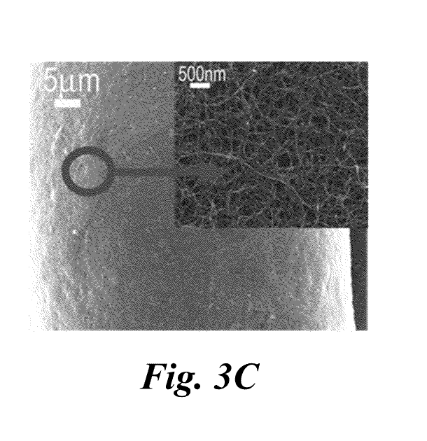

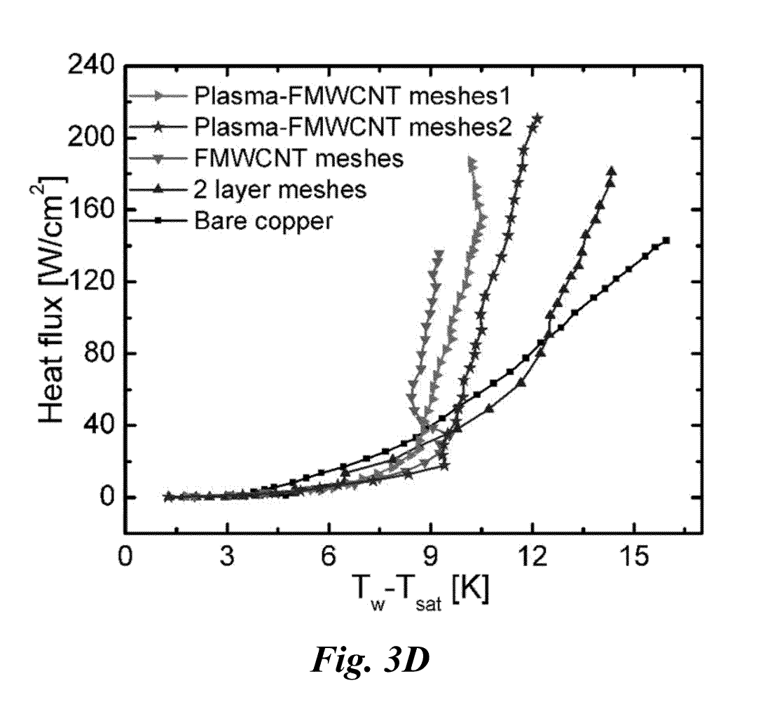

Nucleate boiling is widely used in a variety of heat transfer and chemical reaction applications. The state-of-the-art in enhanced nucleate boiling has focused on using micro/nanoscale structures as well as applying hydrophilic coatings. According to nucleate boiling theory, an ideal interface to achieve high heat transfer coefficient (HTC) and critical heat flux (CHF) shall simultaneously have a combination of properties: high active nucleating site density, optimized cavities for bubble growth and departure and to reduce superheat, minimized flow resistance to improve liquid supply, and evenly distributed liquid film to induce and promote thin film evaporation. Four types of cavities are schematically shown in FIG. 3a. The type I cavities, i.e., superhydrophilic cavities, can substantially reduce superheat, delay the transition boiling, and hence enhance HTC according to nucleate boiling theory, but greatly suffer from flooding. Additionally, the type II cavities, superhydrophobic cavities, can accelerate bubble departure processes, but result in extremely high superheat. According to the most recent study, the type III cavities with superhydrophobic-superhydrophilic surfaces are ideal for nucleate boiling by taking advantage of both of hydrophilic and hydrophobic properties. However, it is challenging to fabricate type III cavities by traditional micro/nano fabrication techniques. In this work, the type IV cavities (right in FIG. 3a) were created by the novel hydrophilic-hydrophobic interfaces enabled by FMWCNTs. The developed FMWCNT interfaces intrinsically include a large amount of submicro/nanoscale interconnected cavities, more importantly, with unique hydrophilic-hydrophobic composite wettability.

Experimental pool boiling study was performed to evaluate type IV cavities. In order to take full advantages of the supernucleating interfaces, FMWCNTs have been coated on two-layer copper mesh screens to form bi-porous structures. The bi-porous structures contain microscale pores (FIG. 3b) and nanopores (FIG. 3c) created by copper meshes and FMWCNT coatings, respectively. Microscale pores are designed to reduce the liquid flow resistance. In total, five samples were tested (FIG. 3d). In this experimental study, flat copper surfaces were used to calibrate the test apparatus. Two-layer sintered copper woven mesh screens are used as the baseline. Three two-layer mesh screens coated with approximately 800 nm thick FMWCNT were tested to understand the effects of the hydrophobic-hydrophilic composite interfaces on nucleate boiling performance. Two of the three FMWCNT meshes were subjected to oxygen plasma treatment for specified time periods. An intermediately functionalized FMWCNT underwent eight minutes of oxygen plasma treatment, while a deeply functionalized FMWCNT mesh underwent fifteen minutes of oxygen plasma treatment.

From five boiling curves summarized in FIG. 3d, the overall nucleate boiling HTC on FMWCNT coatings with and without oxygen plasma treatments has been significantly enhanced compared with bare two-layer copper mesh screens. However, such an enhancement has found to decrease with increasing amount of hydrophilic groups. Specifically, for a given heat flux 135 W/cm², the HTC on the regular FMWCNT coated sample is dramatically enhanced up to 46.5%, but the enhancement is reduced to approximately 32.7% and 20.8% on the oxygen plasma treated samples, respectively. Additionally, CHF is significantly reduced from 181.1 to 135.5 W/cm² on the regular FMWCNT coated sample because the amount of functional groups on the regular FMWCNTs is limited and can degrade the local wettability and hence the liquid supply as indicated in FIG. 1e. This observation is consistent with two oxygen plasma-treated FMWCNTs coatings, where CHFs have been found to increase from 181.1 W/cm² to 187.2 W/cm² and 210.5 W/cm², respectively. It has been experimentally validated that more hydrophilic functional groups lead to improvement of the local liquid supply and therefore the delay of transition boiling. The onset of nucleate boiling (FIG. 3d) on regular FMWCNTs or plasma-treated FMWCNTs has been significantly delayed compared with the bare meshes. That should be caused by the reduced cavity opening size formed by FMWCNTs as indicated in the nucleate boiling theory.

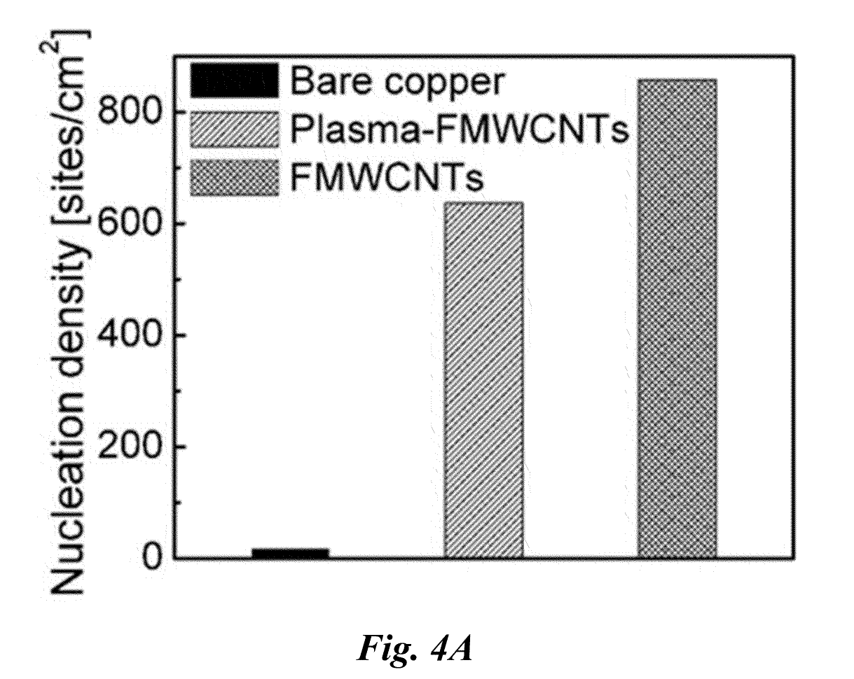

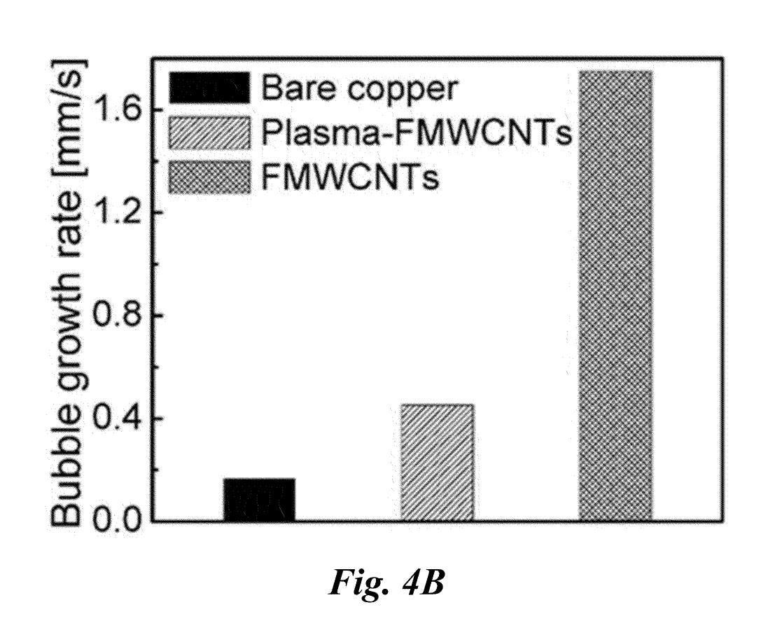

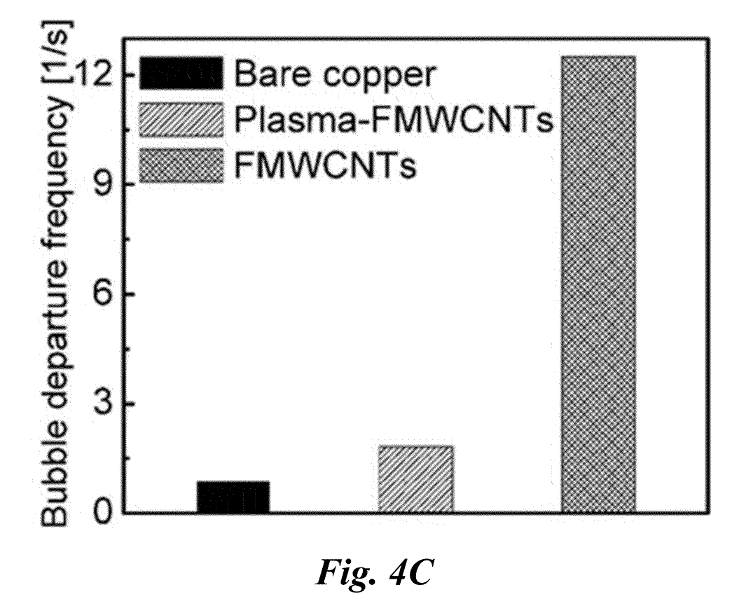

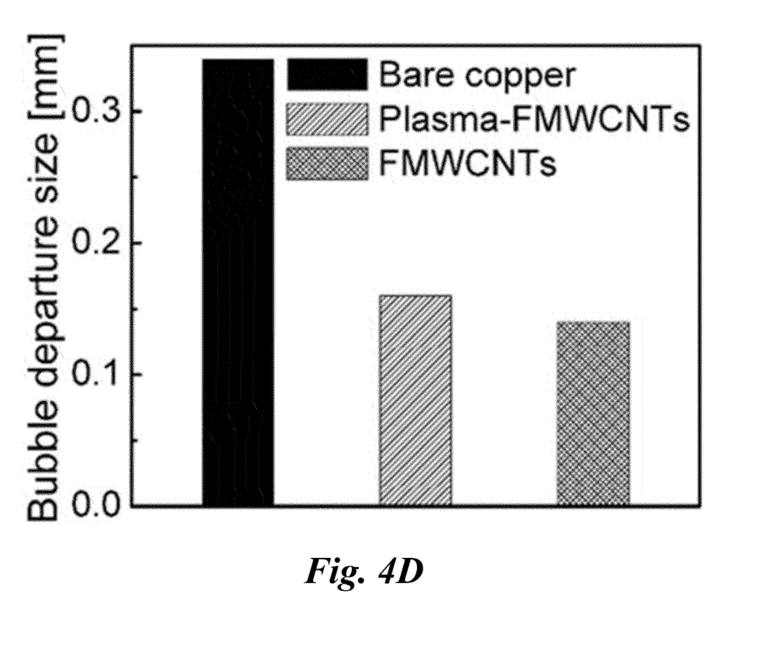

To mechanistically understand the enhanced nucleate boiling on FMWCNT coatings, a visualization study was performed to study the bubble dynamics on three flat substrates: bare copper, FMWCNT coated copper and oxygen plasma treated FMWCNT coated copper at a given super heat, ΔT=9±0.5° C. The dramatic enhancement results from the significant increase of active nucleation site density, bubble growth rate and bubble departure frequency on hydrophobic-hydrophilic composite cavities (FIG. 4). The active nucleation site density on FMWCNT coatings with and without oxygen plasma treatments is at least one order of magnitude higher than that on the bare copper substrate. The reason is that FWMCNT coating significantly increases the total surface area and the hydrophobic area prevents flooding of the cavities formed by FWMCNTs and hence keeps them active during the whole nucleate boiling processes. The highest nucleation site density is on the regular FMWCNT coatings (FIG. 4a). Bubble growth rate on the FMWCNT coatings with and without oxygen plasma treatments (FIG. 4b) is also significantly higher than that on the bare copper surface, which indicates that the evaporation in the microlayer is primarily enhanced by the hydrophilic groups. However, the less hydrophilic groups result higher evaporating rate on the microlayer according to the visualization study. This can be caused by the increased local drag resulting from more hydrophilic groups, which can partially block the water supply to the nanopores or cavities underneath. Additionally, bubble departure frequency from FMWCNT coatings is higher (FIG. 4c) and the average bubble departure diameter is smaller (FIG. 4d) compared with those on the bare copper interface. The reason can be a collective effect of the reduced anchoring surface tension force on hydrophobic-hydrophilic interfaces and the increased inertia force resulting from the bubble growth due to the enhanced evaporation in the microlayer. In summary, the slightly functionalized FMWCNT interfaces perform even better in terms of bubble generation, growth and departure than the oxygen plasma treated FMWCNT interfaces. This observation confirms that hydrophobic cavities are superior to promote the bubble departure processes and hence to enhance the HTC while hydrophilic surfaces are great in improving the local wettability and therefore delaying the transition boiling, i.e., promoting CHF. This study experimentally demonstrates that the enhancements of HTC and CHF can be achieved by inducing hydrophobic-hydrophilic composite wettability, which can be tuned by varying concentration of hydrophilic functional groups.

Microscratch tests were carried out on a CETR microtribometer to examine the bonding strength of the FMWCNT coatings on copper substrates as well as the interactions between individual FMWCNT wires. Usually, superhydrophobic CNTs have poor bonding forces with hydrophilic copper substrates as the hydrophobic interaction is a type of enthalpic or entropic forces, which are weak Van der Waal based forces acting through limited contacts. The microscratch tests have shown that the bonding has been greatly strengthened by introducing hydrophilic functional groups and amphiphilic Nafion. Here, the Nafion polymer served as a gluing media which have a greater density of Van der Waals interactions with the MWCNTs and the copper surface. Moreover, further enhancement of bonding can be achieved by thermally curing the coating at approximately 130° C. for five minutes, above the glass transition temperature of Nafion. As the polymer chain will inter diffuse, allowing greater degree of interlocking and Van der Waals interactions.

A novel type of hydrophobic-hydrophilic composite interfaces synthesized from FMWCNTs has been successfully developed and tested. The apparent contact angle can be conveniently tuned by varying concentration of hydrophilic functional groups. The hydrophobic-hydrophilic composite wettability can dramatically enhance nucleate boiling.

These and other modifications and variations to the present invention may be practiced by those of ordinary skill in the art, without departing from the spirit and scope of the present invention, which is more particularly set forth in the appended claims. In addition, it should be understood the aspects of the various embodiments may be interchanged both in whole or in part. Furthermore, those of ordinary skill in the art will appreciate that the foregoing description is by way of example only, and is not intended to limit the invention so further described in the appended claims.

What is claimed:

1. A method of forming a coated substrate having a plurality of carbon nanoparticles, each nanoparticle defining a surface, the method comprising:
oxidizing the carbon nanoparticles to form oxygen containing end groups on the surfaces of the carbon nanoparticles;
dispersing the oxidized carbon nanoparticles into a polymeric media to form an ink, wherein the polymeric media comprises a polymeric material; and
applying the ink onto a substrate to form a coating, wherein the coating includes the oxidized carbon nanoparticles dispersed within the polymeric material.

2. The method of claim 1, further comprising:
functionalizing the coating to add additional hydrophilic groups thereon.

3. The method of claim 2, wherein the coating is functionalized via oxidation.

4. The method of claim 2, wherein the coating is functionalized via oxygen plasma treatment.

5. The method of claim 4, wherein plasma treatment produces additional oxygen containing end groups on the oxygenized carbon nanoparticles.

6. The method of claim 5, wherein plasma treatment produces oxygen containing end groups on the polymeric material.

7. The method of claim 1, wherein oxidizing the carbon nanoparticles comprises reacting the carbon nanoparticles with a strong acid.

8. The method of claim 7, wherein the strong acid comprises nitric acid, hydrochloric acid, or a mixture thereof.

9. The method of claim 1, wherein the polymeric material comprises a theromplastic polymeric material.

10. The method of claim 1, wherein the carbon nanoparticles comprises multi-walled carbon nanowires.

11. The method of claim 1, wherein the polymeric media further comprises a solvent.

12. A coated substrate formed according to the method of claim 1.
